(19) United States
(12) Patent Application Publication
(10) Pub. No.: US 2013/0346073 A1
(43) Pub. Date: Dec. 26, 2013

(54) AUDIO ENCODER/DECODER APPARATUS

(71) Applicants: Lasse Laaksonen, Nokia (FI); Mikko Tammi, Tampere (FI); Adriana Vasilache, Tampere (FI); Anssi Ramo, Tampere (FI)

(72) Inventors: Lasse Laaksonen, Nokia (FI); Mikko Tammi, Tampere (FI); Adriana Vasilache, Tampere (FI); Anssi Ramo, Tampere (FI)

(73) Assignee: NOKIA CORPORATION, Espoo (FI)

(21) Appl. No.: 13/978,130

(22) PCT Filed: Jan. 12, 2011
(86) PCT No.: PCT/IB2011/050135

§ 371 Date: Jul. 31, 2013

(51) Int. Cl. G10L 21/0316

(52) U.S. Cl. CPC G10L 21/0316
USPC 704/226

(57) ABSTRACT

Apparatus comprising a noise estimator configured to determine a noise estimate for a first part of an audio signal, a comparator configured to compare the noise estimate to an energy threshold parameter, a damping factor determiner configured to determine a damping factor for at least one sub band gain value of a second part of an audio signal, wherein the damping factor is dependent on a result of the comparison and a gain modifier configured to apply the damping factor to the sub band gain value.

### FIELD OF THE APPLICATION

The present invention relates to coding, and in particular, but not exclusively to speech or audio coding.

### BACKGROUND OF THE APPLICATION

Audio signals, like speech or music, are encoded for example to enable efficient transmission or storage of the audio signals. A high compression ratio enables the storage of the data with the same storage capacity or transmitting the signal more efficiently through a communication channel, which in turn can provide the service for more simultaneous users. On the other hand, a high compression ratio may lead to perceived degradation of the compressed audio. The target of audio coding is in general thus to maximize the audio quality at a given compression ratio, or to maintain a given audio quality with as good a compression ratio as possible.

Audio encoders and decoders are used to represent audio based signals, such as music and ambient sounds (which in speech coding terms can be called background noise). These types of coders typically do not utilise a speech model for the coding process, rather they use processes for representing all types of audio signals, including speech.

Speech encoders and decoders (codecs) are usually optimised for speech signals, and can operate at either a fixed or variable bit rate.

An audio codec can also be configured to operate with varying bit rates. At lower bit rates, such an audio codec may work with speech signals at a coding rate equivalent to a pure speech codec. At higher bit rates, the audio codec may code any signal including music, background noise and speech, with higher quality and performance.

In some audio codecs the input signal is divided into a limited number of bands. Furthermore some codecs use the correlation between the low and high frequency bands or regions of an audio signal to improve the coding efficiency of the codecs.

As typically the higher frequency bands of the spectrum are generally quite similar to the lower frequency bands some codecs encode only the lower frequency bands and reproduce the upper frequency bands as a scaled lower frequency band copy. Thus by only using a small amount of additional control information considerable savings can be achieved in the total bit rate of the codec.

For example, if we divide a full-band (20-kHz bandwidth) audio signal equally into two frequency regions, it is often the case that the higher band is quite similar to the lower band. Since the higher frequencies are not generally as perceptually sensitive to coding errors (introduced by the compression) as the low-frequency part of the signal, a lower bit rate (and a higher compression ratio) can be used for the high-frequency content than the corresponding low-frequency content. In addition, the high-frequency coding can be at least partially based on the low-frequency coding. This gives rise to so-called bandwidth extension methods, which are commonly employed in modern, low-rate audio coding.

New speech and audio coding for the next generation telecommunication systems are in development or planning and have been currently referred to as EVS (Enhanced Voice Service) codec for EPS (Evolved Packet System) or LTE (Long Term Evolution) telecommunication systems. The EVS codec is envisioned to provide several different levels of quality (including considerations such as bit rate, audio bandwidth, algorithmic delay, number of channels, interoperability with existing standards, etc.). Of particular interest is a low bit rate super-wideband (SWB, 14-kHz bandwidth) coding that is interoperable with the current 3GPP wideband (WB, 7-kHz bandwidth) standard AMR-WB (Adaptive Multi-Rate Wide Band) codecs. Potential operating points are expected to include SWB speech at about 16 kbps implementing interoperability with AMR-WB 12.65 kbps, as well as SWB speech at 12.65 kbps based on a WB core codec possibly operating at about 10-11 kbps. Such bit rate targets indicate a need for a very low bit rate SWB extension of WB speech and audio codecs. This SWB extension should significantly improve the user experience (i.e. provide high quality) while having low complexity and low delay.

Codecs such as AMR-WB and more recently the proposed EVS standard can deploy at least in part the algebraic code excited linear prediction (ACELP) as a core technology.

It has been shown that the background noise may contribute to the overall ambience of the audio signal. Consequently audio and speech coders have been deploying techniques to represent background noise in an audio signal rather than simply trying to eliminate it as before.

However, the ACELP approach to coding can result in distortions to the spectrum of the coded signal especially during regions of high background noise. Consequently, this can have further ramification when SWB extension methods are used, since these methods typically use the lower band (ACELP coded signal) to efficiently derive the extended band. Therefore inaccuracies in representing the spectral shape of the lower band during regions of high background noise can result in distortion in the SWB extended region of the coded audio signal.

### SUMMARY OF THE APPLICATION

This invention proceeds from the consideration that it is desirable to control the perceived distortion to the SWB extended region of the coded audio signal during regions of high background noise.

There is provided according to the application a method comprising: determining a noise estimate for a first part of an audio signal; comparing the noise estimate to an energy threshold parameter; determining a damping factor for at least one sub band gain value of a second part of an audio signal, wherein the damping factor is dependent on a result of the comparison; and applying the damping factor to the sub band gain value.

The method as claimed in claim may further comprise: determining a pre damping factor for at least one sub band gain value of a second part of an audio signal, wherein the pre damping factor is dependent on a result of the comparison of the noise estimate to a further threshold parameter; and determining a damping factor for the sub band gain value by applying a sub band related weighting factor to the pre damping factor for the at least one sub band gain value, wherein the sub band weighting factor is dependent on the sub band associated with the sub band gain value.

When the result of the comparison indicates a first outcome the determining of the pre damping factor for the at least one sub band gain value of the second part of the audio signal may comprise interpolating between a damping value and a further damping value.

The damping value may be associated with a minimum level of damping, wherein the further damping value may be associated with a maximum level of damping, and wherein the interpolation may be linear and is in proportion to the ratio of the value of the noise estimate relative to the energy range between the energy threshold parameter and the further energy threshold parameter.

When the result of the comparison indicates a second outcome, the determining of the pre damping factor for the at least one sub band gain value of the second part of the audio signal may comprise setting the pre damping factor to be a maximum level of damping

The pre damping factor may be associated with a sub set of sub bands of the second part of the audio signal, and wherein the damping factor corresponding to each sub band gain of the sub set of sub bands may be determined by applying the sub band weighting factor associated with each sub band of the sub set of sub bands to the pre damping factor.

The sub set of sub bands of the second part of the audio signal may comprise a number of the highest frequency sub bands of the second part of the audio signal, and wherein the value of each sub band weighting factor may increase monotonically with each sub band of the sub set of sub bands of the second part of the audio signal.

The sub set of sub bands of the second part of the audio signal may comprise the three highest frequency sub bands, wherein the sub band weighting factor corresponding to third highest frequency sub band may be 0.34, wherein the sub band weighting factor corresponding to the second highest frequency sub band may be 0.67, and wherein the sub band weighting factor corresponding to the highest frequency sub band may be 1.0.

When the result of the comparison of the noise estimate to the energy threshold parameter indicates that the noise estimate is at least less than the energy threshold parameter the damping factor may be determined to be the minimum level of damping.

The minimum level of damping may be 1.

The first part of the audio signal may be a lower frequency region of the audio signal, and wherein the second part of the audio signal may be a higher frequency region of the audio signal.

According to a second aspect there is provided apparatus comprising at least one processor and at least one memory including computer code, the at least one memory and the computer code configured to with the at least one processor cause the apparatus to at least perform: determining a noise estimate for a first part of an audio signal; comparing the noise estimate to an energy threshold parameter; determining a damping factor for at least one sub band gain value of a second part of an audio signal, wherein the damping factor is dependent on a result of the comparison; and applying the damping factor to the sub band gain value.

The apparatus may be further caused to perform: determining a pre damping factor for at least one sub band gain value of a second part of an audio signal, wherein the pre damping factor is dependent on a result of the comparison of the noise estimate to a further threshold parameter; and determining a damping factor for the sub band gain value by applying a sub band related weighting factor to the pre damping factor for the at least one sub band gain value, wherein the sub band weighting factor is dependent on the sub band associated with the sub band gain value.

Determining of the pre damping factor for the at least one sub band gain value of the second part of the audio signal may cause the apparatus to perform interpolating between a damping value and a further damping value when the result of the comparison indicates a first outcome.

The damping value may be associated with a minimum level of damping and the further damping value may be associated with a maximum level of damping, wherein interpolating between a damping value and a further damping value may cause the apparatus to perform linear interpolating in proportion to the ratio of the value of the noise estimate relative to the energy range between the energy threshold parameter and the further energy threshold parameter.

Determining of the pre damping factor for the at least one sub band gain value of the second part of the audio signal may cause the apparatus to perform setting the pre damping factor to be a maximum level of damping when the result of the comparison indicates a second outcome.

The apparatus may be further caused to perform associating the pre damping factor with a sub set of sub bands of the second part of the audio signal, and determining the damping factor corresponding to each sub band gain of the sub set of sub bands may be by applying the sub band weighting factor associated with each sub band of the sub set of sub bands to the pre damping factor.

The sub set of sub bands of the second part of the audio signal may comprise a number of the highest frequency sub bands of the second part of the audio signal, and wherein the value of each sub band weighting factor may increase monotonically with each sub band of the sub set of sub bands of the second part of the audio signal.

The sub set of sub bands of the second part of the audio signal may comprise the three highest frequency sub bands, wherein the sub band weighting factor corresponding to third highest frequency sub band may be 0.34, wherein the sub band weighting factor corresponding to the second highest frequency sub band may be 0.67, and wherein the sub band weighting factor corresponding to the highest frequency sub band may be 1.0.

Determining a damping factor for at least one sub band gain value of a second part of an audio signal may cause the apparatus to determine the damping factor to be the minimum level of damping where the result of the comparison of the noise estimate to the energy threshold parameter indicates that the noise estimate is at least less than the energy threshold parameter.

The minimum level of damping may be 1.

The first part of the audio signal may be a lower frequency region of the audio signal, and wherein the second part of the audio signal may be a higher frequency region of the audio signal.

According to a third aspect there is provided apparatus comprising: a noise estimator configured to determine a noise estimate for a first part of an audio signal; a comparator configured to compare the noise estimate to an energy threshold parameter; a damping factor determiner configured to determine a damping factor for at least one sub band gain value of a second part of an audio signal, wherein the damping factor is dependent on a result of the comparison; and a gain modifier configured to apply the damping factor to the sub band gain value.

The apparatus may further comprise: a pre damping factor determiner configured to determine a pre damping factor for at least one sub band gain value of a second part of an audio signal, wherein the pre damping factor is dependent on a result of the comparison of the noise estimate to a further threshold parameter; and the damping factor determiner may be configured to determine the damping factor for the sub band gain value by applying a sub band related weighting factor to the pre damping factor for the at least one sub band gain value, wherein the sub band weighting factor is dependent on the sub band associated with the sub band gain value.

The pre damping factor determiner may comprise an interpolator configured to interpolate between a damping value and a further damping value when the result of the comparison indicates a first outcome.

The damping value may be associated with a minimum level of damping and the further damping value may be associated with a maximum level of damping, wherein the interpolator may comprise a linear interpolator configured to linear interpolate in proportion to the ratio of the value of the noise estimate relative to the energy range between the energy threshold parameter and the further energy threshold parameter.

The pre damping factor determiner may comprises an associator configured to set the pre damping factor to be a maximum level of damping when the result of the comparison indicates a second outcome.

The apparatus may further comprise a pre damping factor associator configured to associate the pre damping factor with a sub set of sub bands of the second part of the audio signal, and the damping factor determiner may be configured to determine the damping factor corresponding to each sub band gain of the sub set of sub bands by applying the sub band weighting factor associated with each sub band of the sub set of sub bands to the pre damping factor.

The sub set of sub bands of the second part of the audio signal may comprise a number of the highest frequency sub bands of the second part of the audio signal, and wherein the value of each sub band weighting factor may increase monotonically with each sub band of the sub set of sub bands of the second part of the audio signal.

The sub set of sub bands of the second part of the audio signal may comprise the three highest frequency sub bands, wherein the sub band weighting factor corresponding to third highest frequency sub band may be 0.34, wherein the sub band weighting factor corresponding to the second highest frequency sub band may be 0.67, and wherein the sub band weighting factor corresponding to the highest frequency sub band may be 1.0.

The damping factor determiner may be configured to determine the damping factor to be the minimum level of damping where the result of the comparison of the noise estimate to the energy threshold parameter indicates that the noise estimate is at least less than the energy threshold parameter.

The minimum level of damping may be 1.

The first part of the audio signal may be a lower frequency region of the audio signal, and wherein the second part of the audio signal is a higher frequency region of the audio signal.

According to a fourth aspect there is provided apparatus comprising: means for determining a noise estimate for a first part of an audio signal; means for comparing the noise estimate to an energy threshold parameter; means for determining a damping factor for at least one sub band gain value of a second part of an audio signal, wherein the damping factor is dependent on a result of the comparison; and means for applying the damping factor to the sub band gain value.

The apparatus may further comprise: means for determining a pre damping factor for at least one sub band gain value of a second part of an audio signal, wherein the pre damping factor is dependent on a result of the comparison of the noise estimate to a further threshold parameter; and the means for determining a damping factor for the sub band gain value may comprise means for applying a sub band related weighting factor to the pre damping factor for the at least one sub band gain value, wherein the sub band weighting factor is dependent on the sub band associated with the sub band gain value.

The means for determining of the pre damping factor for the at least one sub band gain value of the second part of the audio signal may comprise means for interpolating between a damping value and a further damping value when the result of the comparison indicates a first outcome.

The damping value may be associated with a minimum level of damping and the further damping value may be associated with a maximum level of damping, wherein the means for interpolating between a damping value and a further damping value may comprise means for linear interpolating in proportion to the ratio of the value of the noise estimate relative to the energy range between the energy threshold parameter and the further energy threshold parameter.

The means for determining of the pre damping factor for the at least one sub band gain value of the second part of the audio signal may comprise means for setting the pre damping factor to be a maximum level of damping when the result of the comparison indicates a second outcome.

The apparatus may further comprise means for associating the pre damping factor with a sub set of sub bands of the second part of the audio signal, and the means for determining the damping factor corresponding to each sub band gain of the sub set of sub bands may comprise means of applying the sub band weighting factor associated with each sub band of the sub set of sub bands to the pre damping factor.

The sub set of sub bands of the second part of the audio signal may comprise a number of the highest frequency sub bands of the second part of the audio signal, and wherein the value of each sub band weighting factor may increase monotonically with each sub band of the sub set of sub bands of the second part of the audio signal.

The sub set of sub bands of the second part of the audio signal may comprise the three highest frequency sub bands, wherein the sub band weighting factor corresponding to third highest frequency sub band may be 0.34, wherein the sub band weighting factor corresponding to the second highest frequency sub band may be 0.67, and wherein the sub band weighting factor corresponding to the highest frequency sub band may be 1.0.

The means for determining a damping factor for at least one sub band gain value of a second part of an audio signal may comprise means for determining the damping factor to be the minimum level of damping where the result of the comparison of the noise estimate to the energy threshold parameter indicates that the noise estimate is at least less than the energy threshold parameter.

The minimum level of damping may be 1.

The first part of the audio signal may be a lower frequency region of the audio signal, and wherein the second part of the audio signal may be a higher frequency region of the audio signal.

An electronic device may comprise apparatus as described herein.

A chipset may comprise apparatus as described herein.

Embodiments of the present application aim to address the above problem.

### BRIEF DESCRIPTION OF DRAWINGS

For better understanding of the present invention, reference will now be made by way of example to the accompanying drawings in which:

FIG. 1 shows schematically an apparatus suitable for employing some embodiments of the application;

FIG. 2 shows schematically an audio codec system suitable employing some embodiments of the application;

FIG. 3 shows schematically an encoder part of the audio codec system shown in FIG. 2 according to some embodiments of the application;

FIG. 4 shows a schematic view of the higher frequency region encoder portion of the encoder as shown in FIG. 3 according to some embodiments of the application;

FIG. 5 shows a flow diagram illustrating the operation the audio encoder as shown in FIGS. 3 and 4 according to some embodiments of the application; and

FIG. 6 shows schematically a decoder part of the audio codec system as shown in FIG. 2.

### DESCRIPTION OF SOME EMBODIMENTS OF THE APPLICATION

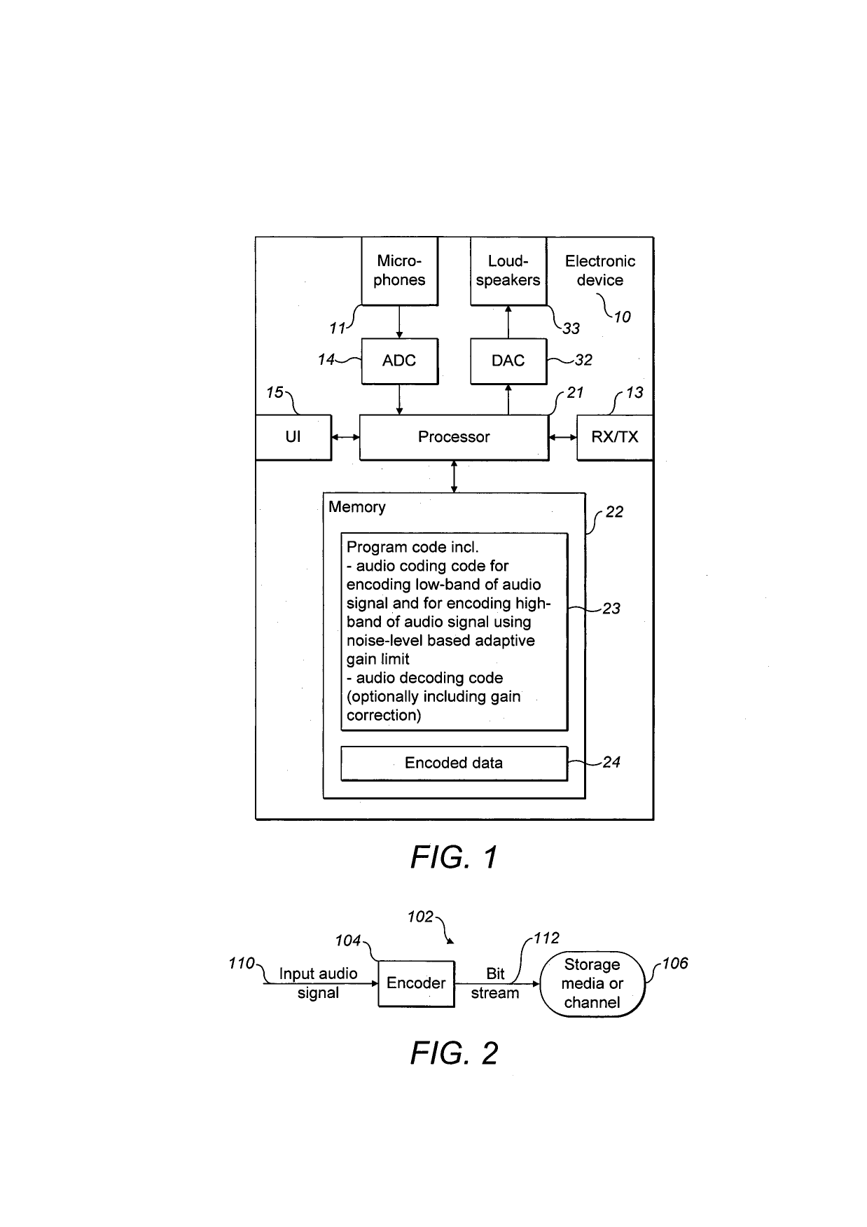

The following describes in more detail possible codec mechanisms for the provision of scalable super-wideband extension for audio codecs. In this regard reference is first made to FIG. 1 which shows a schematic block diagram of an exemplary electronic device or apparatus 10, which may incorporate a codec according to embodiments of the application.

The apparatus 10 may for example be a mobile terminal or user equipment of a wireless communication system. In other embodiments the apparatus 10 may be an audio-video device such as video camera, a Television (TV) receiver, audio recorder or audio player such as a mp3 recorder/player, a media recorder (also known as a mp4 recorder/player), or any computer suitable for the processing of audio signals.

The apparatus 10 in some embodiments comprises a microphone 11, which is linked via an analogue-to-digital converter (ADC) 14 to a processor 21. The processor 21 is further linked via a digital-to-analogue (DAC) converter 32 to loudspeakers 33. The processor 21 is further linked to a transceiver (RX/TX) 13, to a user interface (UI) 15 and to a memory 22.

The processor 21 may be configured to execute various program codes. The implemented program codes in some embodiments comprise an audio encoding code for encoding a lower frequency band of an audio signal and a higher frequency band of an audio signal. The implemented program codes 23 in some embodiments further comprise an audio decoding code. The implemented program codes 23 can in some embodiments be stored for example in the memory 22 for retrieval by the processor 21 whenever needed. The memory 22 could further provide a section 24 for storing data, for example data that has been encoded in accordance with embodiments of the application.

The encoding and decoding code in embodiments can be implemented in hardware or firmware.

The user interface 15 enables a user to input commands to the apparatus 10, for example via a keypad, and/or to obtain information from the apparatus 10, for example via a display. In some embodiments a touch screen may provide both input and output functions for the user interface. The apparatus 10 in some embodiments comprises a transceiver 13 suitable for enabling communication with other apparatus, for example via a wireless communication network.

It is to be understood again that the structure of the apparatus 10 could be supplemented and varied in many ways.

A user of the apparatus 10 for example can use the microphone 11 for inputting speech or other audio signals that are to be transmitted to some other apparatus or that are to be stored in the data section 24 of the memory 22. A corresponding application in some embodiments can be activated to this end by the user via the user interface 15. This application in these embodiments can be performed by the processor 21, causes the processor 21 to execute the encoding code stored in the memory 22.

The analogue-to-digital converter (ADC) 14 in some embodiments converts the input analogue audio signal into a digital audio signal and provides the digital audio signal to the processor 21. In some embodiments the microphone 11 can comprise an integrated microphone and ADC function and provide digital audio signals directly to the processor for processing.

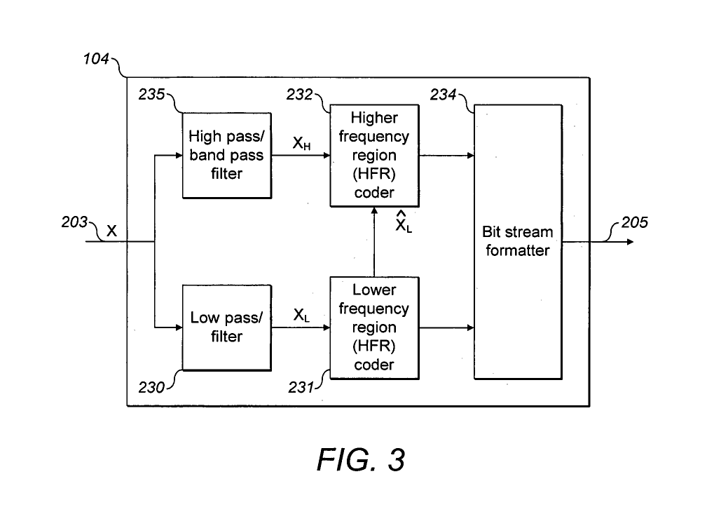

The processor 21 in such embodiments then can process the digital audio signal in the same way as described with reference to FIGS. 3 to 5.

The resulting bit stream can in some embodiments be provided to the transceiver 13 for transmission to another apparatus. Alternatively, the coded audio data in some embodiments can be stored in the data section 24 of the memory 22, for instance for a later transmission or for a later presentation by the same apparatus 10.

The apparatus 10 in some embodiments can also receive a bit stream with correspondingly encoded data from another apparatus via the transceiver 13. In this example, the processor 21 may execute the decoding program code stored in the memory 22. The processor 21 in such embodiments decodes the received data, and provides the decoded data to a digital-to-analogue converter 32. The digital-to-analogue converter 32 converts the digital decoded data into analogue audio data and can in some embodiments output the analogue audio via the loudspeakers 33. Execution of the decoding program code in some embodiments can be triggered as well by an application called by the user via the user interface 15.

The received encoded data in some embodiments can also be stored instead of an immediate presentation via the loudspeakers 33 in the data section 24 of the memory 22, for instance for later decoding and presentation or decoding and forwarding to still another apparatus.

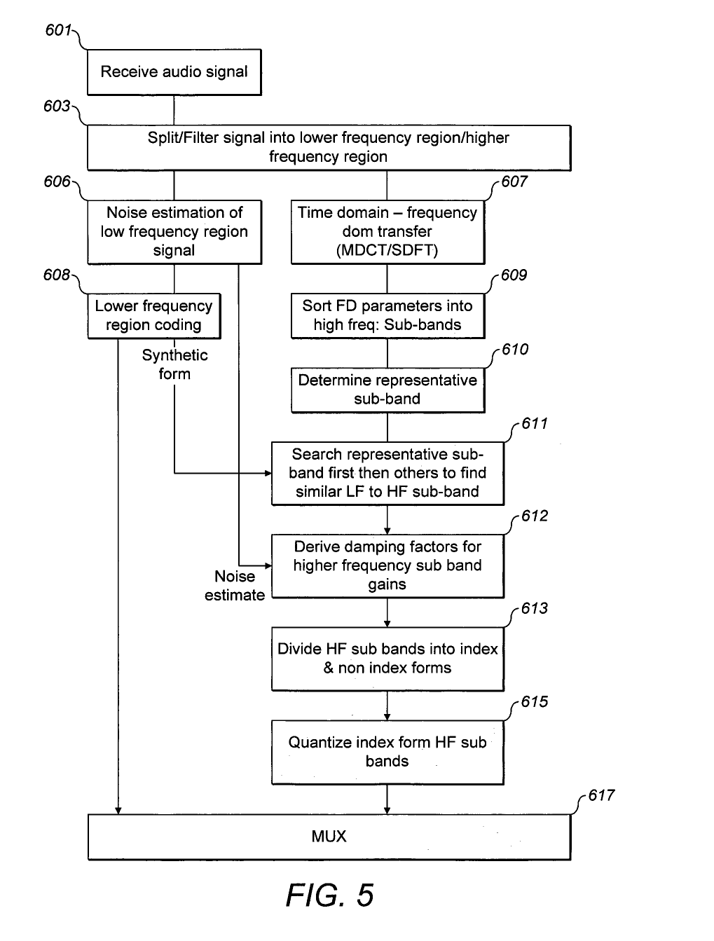

It would be appreciated that the schematic structures described in FIGS. 3 to 4 and 6 and the method steps shown in FIGS. 5 and 7 represent only a part of the operation of an audio codec as exemplarily shown implemented in the apparatus shown in FIG. 1.

The general operation of audio codecs as employed by embodiments of the application is shown in FIG. 2. General audio coding comprise an encoder, as illustrated schematically in FIG. 2. Illustrated by FIG. 2 is a system 102 with an encoder 104, and a storage or media channel 106. It would be understood that as described above some embodiments of the apparatus 10 can comprise or implement an encoder 104.

The encoder 104 compresses an input audio signal 110 producing a bit stream 112, which in some embodiments can be stored or transmitted through a media channel 106. The bit stream 112 can be received within the decoder 108. The decoder 108 decompresses the bit stream 112 and produces an output audio signal 114. The bit rate of the bit stream 112 and the quality of the output audio signal 114 in relation to the input signal 110 are the main features which define the performance of the coding system 102.

FIG. 3 shows schematically an encoder 104 according to some embodiments of the application. The encoder 104 in such embodiments comprises an input 203 arranged to receive an audio signal. The input 203 is connected to a low pass filter 230 and high pass/band pass filter 235. The low pass filter 230 furthermore outputs a signal to the lower frequency region (LFR) coder (otherwise known as the core codec) 231. The lower frequency region coder 231 is configured to output signals to the higher frequency region (HFR) coder 232. The high pass/band pass filter 235 is connected to the HFR coder 232. The LFR coder 231 and the HFR coder 232 are configured to output signals to the bitstream formatter 234 (which in some embodiments of the invention is also known as the bitstream multiplexer). The bitstream formatter 234 is configured to output the output bitstream 112 via the output 205.

In some embodiments of the invention the high pass/band pass filter 235 may be optional, and the audio signal passed directly to the HFR coder 232. In some further embodiments the operation of the low pass filter 230 and high pass filter 235 can be implemented as a quadrature mirror filter (QMF) configuration which outputs a lower frequency component to the LFR coder 231 and a higher frequency component to the HFR coder 232.

The operation of these components is described in more detail with reference to the flow chart, FIG. 5, showing the operation of the coder 104.

The audio signal is received by the coder 104. In some embodiments the audio signal is a digitally sampled signal. In some other embodiments the audio input may be an analogue audio signal, for example from a microphone, which is analogue to digitally (A/D) converted in the coder 104. In some further embodiments the audio input is converted from a pulse code modulation digital signal to amplitude modulation digital signal.

The receiving of the audio signal is shown in FIG. 5 by step 601.

The low pass filter 230 and the high pass/band pass filter 235 receive the audio signal and define a cut-off frequency about which the input signal 110 is filtered.

The received audio signal frequencies below the cut-off frequency are passed by the low pass filter 230 to the lower frequency region (LFR) coder 231. The received audio signal frequencies above the cut-off frequency are passed by the high pass filter 235 to the higher frequency region (HFR) coder 232. In some embodiments of the invention the signal is optionally down sampled in order to further improve the coding efficiency of the lower frequency region coder 231. In other words in some embodiments there can be means for determining from an audio signal at least a first part and a second part. The dividing means may in some embodiments comprise: filtering means configured to filter the audio signal into a first part representing a lower frequency region and a second part representing a higher frequency region.

The splitting or filtering of the signal into lower frequency regions and higher frequency regions is shown in FIG. 5 by step 603.

The encoder 104 can incorporate a noise estimator 233 for estimating the background noise in the input signal 203. In other words in some embodiments there can comprise means for determining a noise estimate for a first part of an audio signal. In such embodiments the first part of the audio signal can be the lower frequency components of the audio signal.

In some embodiments the noise estimator 233 may be situated in the encoder 104 such that the noise is estimated over the low frequency signal 236. In these embodiments the noise estimator 233 can take the form of a processing entity embedded within the low frequency region coder 231.

It other embodiments the noise estimator 233 may be deployed as a separate functional processing element to that of the lower frequency region coder 231. In these embodiments the noise estimator 233 can be configured to be connected directly to the low pass filtered signal 236.

Typically, the arrangement comprising a noise estimator 233 as a separate processing functional unit may be used in embodiments which deploy a low frequency region coder 231 without a noise estimator.

It is to be understood that other embodiments may arrange for the noise estimator 233 to directly receive the input audio signal 203. These embodiments may then determine a noise estimate for the full bandwidth of the input audio signal 203.

It is to be further understood that the noise estimator 233 can be deployed to produce a noise estimate on a per audio frame basis.

In embodiments the noise estimator 233 can determine an estimate for the noise of the low pass filtered signal 236 in the spectral domain. This may be realised by initially deploying a discrete fourier transform or the like in order to convert the low pass filtered signal 236 into a spectral domain signal. The spectral components of the spectral domain signal may then be divided into a plurality of critical bands and the energy of each critical sub band may then obtained by summing the energy value for each spectral component within the sub band.

In some embodiments noise estimation may be performed for each critical sub band using a two stage process. In the first stage, the noise estimator 233 may determine the noise energy within a critical band to be recursively dependent on the noise energy of the same critical band in a previous frame. In other words, the noise energy for the critical band may be updated if the energy value falls within the limits of an adaptable threshold, where the adaptable threshold can be dependent on the noise energy of the corresponding critical band from the previous frame. In this instance the noise energy estimate for the particular critical band may be updated to a smoothed energy value. The smoothed energy value may be derived by calculating a moving average energy value over consecutive frames for the particular critical band in question.

It is to be understood that the noise energy estimate calculated during the first stage can be updated for those critical bands which exhibit energy levels that are too low to be associated with frequency components of active speech or audio.

The second stage of noise estimation may be applied to critical bands which have not had their noise energies updated in the first stage, in other words critical bands which have an energy level higher than the adaptive threshold for the critical band.

The noise energy estimate for critical bands of the second stage can be updated with a smooth energy level which is specific for the particular critical band. The updating may only be performed if it is determined that a particular critical band is not classified as either active voice or audio.

In embodiments the critical band classification may be based on a number of signal parameters such as: pitch stability, signal stationarity, voicing metrics, and ratios between differing orders of LPC filtered error residual signals.

It is to be understood that the above process determines a noise estimate on a per audio frame basis.

It is to be further understood that the overall noise estimate for an audio frame can then be determined by summing the noise estimate for each critical band within the spectrum of the audio frame.

An example embodiment of a noise estimator 233 can be found in section 6.7 of the International Telecommunications Union standard G.718 entitled Frame Error Robust Narrowband and Wideband Embedded Variable Bit Rate Coding of Speech and Audio from 8-32 kbit/s.

It is to be understood that other embodiments can deploy other noise estimation schemes known in the art.

For instance, other embodiments may deploy a noise estimation scheme which returns a noise estimate for each sub band within an audio frame of the input low frequency signal 236.

The noise estimate for a current audio frame may then be arranged to be conveyed from the noise estimator 233 to an input to the high frequency region coder 232.

With reference to FIG. 3, the HFR coder 232 is depicted as receiving the noise estimate from the noise estimator 233 within the LFR coder 231 via the connection 237.

Noise estimation of the low frequency region signal is shown as processing step 606 in FIG. 5.

The LFR coder 231 receives the low frequency (and optionally down sampled) audio signal 236 and applies a suitable low frequency coding upon the signal. In a first embodiment of the invention the low frequency coder 231 applies a quantization and Huffman coding with 32 low frequency sub-bands. The input signal 110 in such embodiments can be divided into sub-bands using an analysis filter bank structure. Each sub-band in some embodiments can be quantized and coded utilizing the information provided by a psychoacoustic model. The quantization settings as well as the coding scheme can in some embodiments be dictated by the psychoacoustic model applied. The quantized, coded information is then in such embodiments sent to the bit stream formatter 234 for creating a bit stream 112.

Furthermore the LFR coder 231 in some embodiments applies an inverse coding to the coded LFR signals to generate a synthetic LFR signal. In some embodiments the LFR coder 231 can furthermore convert the synthetic lower frequency content using a modified discrete cosine transform (MDCT) to produce frequency domain realizations of the synthetic LFR signal. These frequency domain realizations \hat{X}_{L} are in some embodiments passed to the HFR coder 232. In other words in at least one embodiment there comprises first encoding means for encoding the first part of the audio signal for generating a first encoded audio signal.

This lower frequency region coding is shown in FIG. 5 by step 608.

In some other embodiments other low frequency codecs may be employed in order to generate the core coding output which is output to the bitstream formatter 234 and used to generate the synthetic LFR signal and frequency domain LFR signal. Examples of these further embodiment low frequency codecs include but are not limited to advanced audio coding (AAC), MPEG layer 3 (MP3), the ITU-T G.718, and ITU-T G.729.1.

Where the lower frequency region coder 231 does not effectively output a frequency domain synthetic output as part of the coding process the low frequency region (LFR) coder 231 may furthermore comprise a low frequency decoder and frequency domain converter (not shown in FIG. 3) to generate a synthetic reproduction of the low frequency signal. These can in embodiments be converted into frequency domain representations and, if needed, partitioned into a series of low frequency sub-bands which are sent to the HFR coder 232.

This allows in some embodiments the choice of the lower frequency region coder 231 to be made from a wide range of possible coder/decoders and as such the embodiments are not limited to a specific low frequency or core code algorithm which produces frequency domain information as part of the output.

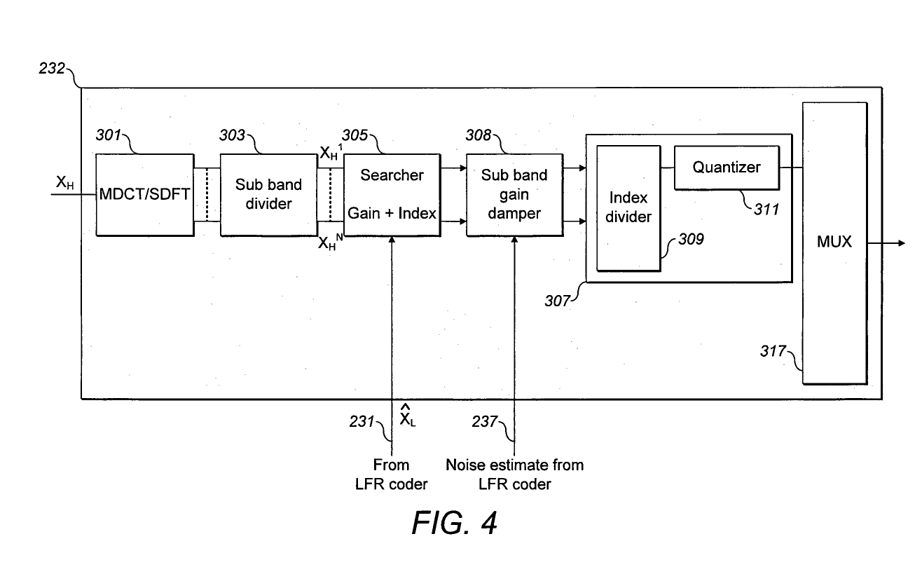

The higher frequency region (HFR) coder 232 is schematically shown in further detail in FIG. 4.

The higher frequency region coder 232 receives the signal from the high pass/band pass filter 235. In some embodiments the HFR coder 232 comprises a modified discrete cosine transform (MDCT)/shifted discrete Fourier transform (SDFT) processor 301 configured to receive the signal from the high pass/band pass filter 235 and transform a time domain signal into a frequency domain signal. It would be understood that any suitable time domain to frequency domain converter may be employed.

The frequency domain representations of the higher frequency components can in some embodiments be output to a sub-band divider 303.

The operation of time domain to frequency domain transformation is shown in FIG. 5 by step 607.

In some embodiments the HFR coder 232 further comprises a sub-band divider 303. The sub-band divider 303 in such embodiments receives the output from the MDCT/SDFT and is configured to divide the frequency domain representations of the higher frequency audio signal into short frequency sub-bands. These frequency sub-bands in some embodiments can be of the order of 500-800 Hz wide. In some embodiments the frequency sub-bands have non-equal band-widths.

In some embodiments, the frequency sub-band bandwidth is constant, in other words does not change from frame to frame. In some other embodiments, the frequency sub-band bandwidth is not constant and a frequency sub-band may have bandwidth which changes over time.

In some embodiments, this variable frequency sub-band bandwidth allocation may be determined based on a psycho-acoustic modelling of the audio signal. These frequency sub-bands may furthermore be in various embodiments successive (in other words, one after another and producing a continuous spectral realisation) or partially overlapping for example for the purpose of smoothing the spectral shape over successive frequency sub-bands.

The sub-band frequency domain representations X_{H}¹ . . . X_{H}ⁿ can be passed in some embodiments of the application to the sub-band searcher 305.

The reference means may thus in some embodiments further comprise: dividing means for dividing the second part of the audio signal into a plurality of sections; processing means for determining for each of the plurality of sections a cross-correlation value between each combination of the plurality of sections; and selection means for selecting as the reference section the section with the largest average cross-correlation value.

The frequency domain sub-band organisation operation is shown in FIG. 5 by step 609.

In some embodiments the higher frequency region coder 232 comprises a searcher 305, which having received the higher frequency sub-band representations X_{H}¹ . . . X_{H}ⁿ, and the synthetic lower frequency representations \hat{X}_{L}, is configured to search for each of the higher frequency sub-band representations a selection or sub-set of the synthetic lower frequency representations which best represents or ‘matches’ the higher frequency sub-band representation.

In some embodiments the searcher 305 is further configured to perform an initial pre-processing on the higher frequency sub-band representations, to assist in the speed of determining the matching. For example in some embodiments the searcher 305 can be configured to control the search by limiting the range of the lower frequency samples available for searching to a subset of the lower frequency components. In some embodiments the pre-processing on the higher frequency sub-band representations may be the same or different for each of the higher frequency sub-bands.

In the following described examples, the searcher 305 can pre-process the higher frequency sub-bands to exploit possible correlation between the lower frequency regions for each higher frequency sub-band selected. In other words the searcher 305 limits the range of lower frequency samples searched by determining the most ‘representative’ lower sub-band to be searched first. In other words if considering a first higher frequency sub-band and a second higher frequency sub-band which are adjacent in frequency, a lower frequency region providing a good match with the second higher frequency sub-band is likely to be found in the proximity of a lower frequency region found to provide a good match with the first higher frequency sub-band.

The searcher 305 can in some embodiments comprise a subset selector configured to select a subset of the lower frequency sub-band samples and a sub-series searcher configured to find a matching subseries for the subset of the lower frequency samples that is suitable for coding the higher frequency samples. The subset selector can in some embodiments select the subset dependent on the input higher frequency series of samples. In other words the subset can be dependent on the higher frequency sub-band index (j).

The sub-set selector can significantly reduce the number of calculations required compared to using the whole lower frequency component samples to determine the matching. The selection of the subset of the frequency components can use a predetermined methodology for selecting the subset. In some other embodiments of the subset selection may be carried out by one of a plurality of different methodologies.

The sub-set selector can in some embodiments achieve the reduced subset \tilde{X}_{L}^{j}(k) by selecting the range of samples in the lower frequency range \hat{X}_{L} that are most probably the perceptually most important.

The sub-set selector can in some embodiments determine a ‘reference’ higher frequency sub-band X_{H}^{j}(k). The ‘reference’ higher frequency band in some embodiments can be determined by the sub-set selector as the lowest frequency higher frequency band e.g. j=0. This is because typically the lower frequency components of the higher frequency sub-bands are more relevant to producing high quality encoding.

However in some embodiments the sub-set selector can in some embodiments adaptively select the ‘reference’ higher frequency sub-band based on the characteristics of the higher frequency sub-bands. For example, in some embodiments a similarity measurement, such as a cross-correlation, can be applied by the sub-set selector to the higher frequency sub-bands to identify the higher frequency sub-band that has the greatest similarity to the other higher frequency sub-bands. In such embodiments the greatest similarity or ‘reference’ or representative higher frequency sub-band can be the higher frequency sub-band with the highest cross-correlation with another higher frequency sub-band. In some other embodiments the sub-set selector can determine the representative higher frequency sub-band as the higher frequency sub-band with the highest median or mean cross-correlation with the other higher frequency sub-bands.

The operation of determining the representative sub-band is shown in FIG. 5 by step 610.

The searcher 305, or in some embodiments the sub-series searcher can then be configured to process the full lower frequency band or range \hat{X}_{L} (k) and the representative higher frequency band X_{H}^{j}(k) to identify a ‘matching’ reference sub-series of the frequency band or range \hat{X}_{L}(k). The sub-series searcher in some embodiments can determine a matching parameter by defining a similarity cost function S(d), which can be mathematically represented as:

$$S ( d ) = \vert \frac{{\sum }_{k = 0}^{{n}_{j} - 1} ( {X}_{H}^{j} ( k ) {\hat{X}}_{L} ( d + k ) )}{\sqrt{{\sum }_{k = 0}^{{n}_{j} - 1} {{\hat{X}}_{L} ( d + k )}^{2} }} \vert$$

where nⱼ is the length of the higher frequency sub-band and d is the index of the lower frequency range.

In some embodiments the searcher can be configured to, as well as determining the index d which maximises the similarity function, determine also a series of gain values to assist in the scaling approximations. For example in some embodiments a linear domain scaling gain α₁(j) can be determined as:

$${α}_{1} ( j ) = \frac{{\sum }_{k = 0}^{{n}_{j} - 1} ( {X}_{H}^{j} ( k ) {\hat{X}}_{L}^{j} ( k ) )}{{\sum }_{k = 0}^{{n}_{j} - 1} {{\hat{X}}_{L} ( d + k )}^{2}} .$$

Furthermore in some embodiments an energy and logarithmic domain scaling gain α₂(j) can be determined by the searcher 305.

$${α}_{2} ( j ) = \frac{{\sum }_{k = 0}^{{n}_{j} - 1} ( ( {log}_{10} ( \vert {α}_{1} ( j ) {\hat{X}}_{L}^{j} ( k ) \vert ) - {M}_{j} ) ( {log}_{10} ( \vert {X}_{H}^{j} ( k ) \vert ) - {M}_{j} ) )}{{\sum }_{k = 0}^{{n}_{j} - 1} {( {log}_{10} ( \vert {α}_{1} ( j ) {\hat{X}}_{L}^{j} ( k ) \vert ) - {M}_{j} )}^{2}} \\ where {M}_{j} = {max}_{k} ( {log}_{10} ( \vert {α}_{1} ( j ) {\hat{X}}_{L}^{j} ( k ) \vert ) ) .$$

The second encoding means may thus in some embodiments further comprise a scaling means for determining at least one scaling parameter configured to define a scaling between a section of the second part of the audio signal and a section of the first part of the audio signal, wherein the section of the first part of the audio signal may be the first part of the audio signal associated with the indicator for the first section of the second part of the audio signal. Wherein the at least one scaling parameter may comprise at least one of: a linear domain scaling parameter; and a logarithmic domain scaling parameter.

The apparatus may further comprise reference means for determining a reference section of the second part of the audio signal, wherein the first section of the second part of the audio signal is selected as the reference section.

The overall synthesized sub-band \hat{X}_{H}^{j}(k) can therefore be determined in the decoder from the above values as \hat{X}_{H}^{j}(k)=ζ(k)10^{α}^{₂}^{(j)(log} ^{₁₀}^{(|α}^{₁}^{(j)\hat{X}}^{_{L}}^{^{j}}^{(k)|)-M}^{ⱼ}^{)+M}^{ⱼ} where ζ(k) is −1 if α₁(j)\hat{X}_{L}^{j}(k) is negative and otherwise 1.

Consequently a full or exhaustive search of the lower frequency values using the reference higher frequency sub-band in such embodiments produces a reference sub-series within the lower frequency samples for searching. In other words for the non reference or relevant higher frequency sub-bands the search is started in the neighbourhood of the lower frequency sub-series defined by \hat{X}_{L}(dₘₐₓ).

The sub-series searcher can be configured to further define a search ranges SR which defines the number of search positions from the reference matched lower frequency range. The number of search positions in some embodiments can be for example, between 30% and 150% of the size of the sub-band. However any suitable search range can be used in some embodiments.

The searcher 305 can in some embodiments be configured to then output the high frequency sub-band match index and gain values or any other suitable scaling parameters to a sub band gain damper 308.

The operation of searching the lower frequency region for matches for higher frequency sub-bands and specifically the searching for a match for the representative or reference higher frequency sub-band first and using the results from this search to assist the other searches is shown in FIG. 5 by step 611.

In some embodiments the HFR coder comprises a sub band gain damper 308 configured to provide noise dependant damping on the sub band gain values of the higher frequency audio signal.

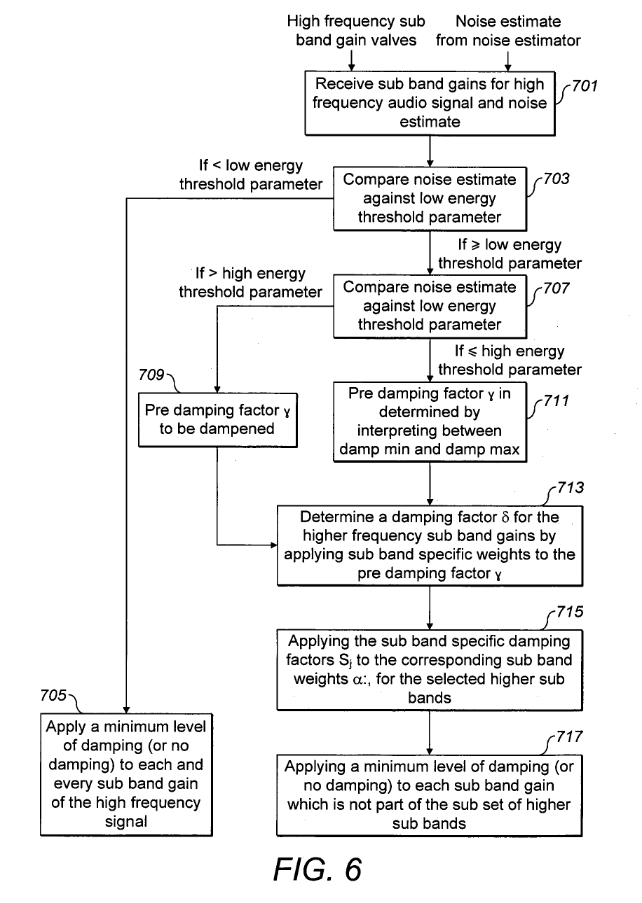

The operation of the sub band gain damper 308 is described in more detail with reference to the flow chart of FIG. 6.

The sub band gain damper 308 can be configured to at least receive the sub band gain values of the high frequency audio signal from the searcher 305, and the noise estimate for the current audio frame from the noise estimator 233.

The receiving of the sub band gain values and noise estimate is shown in FIG. 6 as processing step 701.

In embodiments the sub band gain damper 308 may employ a multi level threshold energy approach in determining if a damping factor should be applied to a high frequency sub band gain value. In other words the sub band gain damper 308 may determine if a particular sub band gain value requires damping by analysing the value of the noise estimate for the current frame and comparing it to at least one energy threshold parameter. Therefore in at least some embodiments the value of the noise estimate for the current frame can be compared to at least one energy threshold parameter by a comparator configured to compare, or means for comparing, the noise estimate to an energy threshold parameter.

Initially the value of the noise estimate for the current audio frame may be compared against a low (first) energy threshold parameter.

The comparing of the noise estimate against the low energy threshold parameter is shown as decision step 703 in FIG. 6.

The outcome of the above decision step can be used to determine if the value of the noise estimate is below the value of the low energy threshold parameter,

Upon such a determination each high frequency sub band gain value can receive a minimum level of damping. Thus in at least one embodiment there can comprise a damping factor determiner configured to determine or means for determining a damping factor for at least one sub band gain value of a second part of an audio signal, wherein the damping factor is dependent on a result of the comparison. In such embodiments the second part of the audio signal can be the higher frequency sub bands. Furthermore there can also comprise in some embodiments a gain modifier configured to apply, or means for applying, the damping factor to the sub band gain value

In embodiments this may be implemented by multiplying a sub band gain value with a damping factor which provides a minimum level of damping.

In a first group of embodiments the minimum level of damping may be equivalent to applying no damping. In other words, in these embodiments the damping factor may be determined to be unity or 1.0.

The step of applying a minimum damping factor to all the high frequency sub band gains when the outcome of the comparison step 703 indicates that the noise estimate is less than the low energy threshold parameters is shown as processing step 705 in FIG. 6.

Other operating conditions of the sub band gain damper 308 may produce an outcome to the above comparison step which indicates that the noise estimate for the current audio frame is greater than or equal to the low energy threshold parameter value.

In such operating instances of the sub band gain damper 308 it may be determined that a higher level of damping is required.

In some embodiments the higher level of damping may predominantly be focussed towards the higher frequency sub bands of the high frequency audio signal as these sub bands are known to be more sensitive to the effects of background noise.

The higher level of damping may be achieved in embodiments by deriving a pre damping weight for the higher frequency sub bands.

In embodiments the pre damping weight can be determined based on the energy level of the noise estimate. In such embodiments the sub band gain damper can comprise a pre damping factor determiner configured to, or means for determining a pre damping factor for at least one sub band gain value of the second part of an audio signal, wherein the pre damping factor is dependent on the result of the comparison of the noise estimate to a further threshold parameter. Furthermore in such embodiments the damping factor determiner configured to determine, or means for determining, the damping factor for the sub band gain value can be performed by applying the sub band related weighting factor to the pre damping factor for the at least one sub band gain value, wherein the sub band weighting factor is dependent on the sub band associated with the sub band gain value.

The pre damping weight may then be used to derive a sub band specific damping factor for application to corresponding higher frequency sub band gains. In other words, a sub band specific damping factor may be applied to each sub band gain value of a sub set of high frequency sub bands. The sub set of high frequency sub bands may comprise the sub bands associated with the higher sub bands of the high frequency audio signal.

In embodiments, calculating the pre damping factor can involve subjecting the noise estimate to a further comparison against a high (second) energy threshold parameter.

It is to be understood in embodiments that the comparison against the high (second) energy threshold parameter may be performed if the low energy threshold parameter is equalled or exceeded by the noise estimate

The step of comparing the noise estimate against the high (second) energy threshold parameter is shown as the comparison step 707 in FIG. 6.

In embodiments comparing the noise estimate against the high threshold parameter can result in two outcomes. These can in some embodiments be called the first and second outcomes.

The first outcome can indicate that the noise estimate is higher than or equal to the value of the high energy threshold parameter. In this instance the pre damping factor can be set at a maximum level of damping. In other words the pre damping factor δ may be determined to be a maximum level of damping dampₘₐₓ.

It is to be understood in this instance the pre damping factor is set at the maximum level of damping for all sub bands to which the eventual damping is applied. In such embodiments the apparatus can be considered to comprise an associator, or other means for setting the pre damping factor to be a maximum level of damping when the result of the comparison indicates an outcome where the noise estimate is higher than or equal to the value of the high energy threshold parameter.

In other words, in this particular instance the step of determining the pre damping factor γ for a sub band gain to be the maximum level of damping is shown as processing step 709 in FIG. 6.

The second outcome of the above comparison step may indicate that the noise estimate is below the value of the high energy threshold parameter. For this operating instance of the gain damper 308 the pre damping factor γ may be determined to be a value which is proportional to the ratio of the noise estimate relative to the energy range spanned between the low and high energy threshold parameters.

In a first group of embodiments the pre damping factor γ for the operating instance of the noise estimate being below the value of the high energy threshold parameter may be determined by interpolating between a minimum level of damping dampₘᵢₙ and a maximum level of damping dampₘₐₓ.

In an example of a first group of embodiments the interpolation may be linear and proportional to the value of the noise estimate relative to the energy range between the low and high energy threshold parameters. In such embodiments therefore the apparatus can comprise an interpolator configured to interpolate, or means for interpolating between a damping value and a further damping value when the result of the comparison indicates the first outcome where the noise estimate is below the value of the high energy threshold parameter but above the low energy threshold parameter. In such embodiments the damping value can be the value associated with the minimum level of damping dampₘᵢₙ and the further damping value can be the value associated with the maximum level of damping dampₘₐₓ. Furthermore as discussed herein the interpolator or means for interpolating can in some embodiments comprise a linear interpolator configured to linearly interpolate in proportion to the ratio of the value of the noise estimate relative to the energy range between the energy threshold parameter and the further energy threshold parameter.

For example, in a first group of embodiments the pre damping factor γ for a the current audio frame deploying the above linear interpolation may be expressed as

$$γ = \frac{{N}_{ɛ} - {Th}_{low}}{{Th}_{high} - {Th}_{low}} \cdot {damp}_{min} + ( 1 - \frac{{N}_{ɛ} - {Th}_{low}}{{Th}_{high} - {Th}_{low}} ) \cdot {damp}_{max} ,$$

where N_{ε} is the noise estimate for the current audio frame, Th_{low} and Th_{high} are the low and high energy threshold parameters respectively, and dampₘᵢₙ and dampₘₐₓ are the minimum and maximum levels of damping respectively.

In examples of the first group of embodiments the values dampₘᵢₙ and dampₘₐₓ can have values of 1.0 and 0.1 respectively.

It is to be further understood that these values may be selected on a perceptual basis by conducting a series of experiments in the form of listening tests.

Therefore it is to be appreciated that other example embodiments can adopt other values for the above parameters of dampₘᵢₙ and dampₘₐₓ.

The step of determining the pre damping factor γ for a sub band gain to be an interpolated value between a minimum level of damping and a maximum level of damping is shown as processing step 711 in FIG. 6.

It is to be understood in some embodiments that the pre damping factor γ as determined by processing steps 709 or 711 is a universal factor for the current audio frame which can be directly applied to particular sub band gains. In these embodiments each sub band gain to which a damping factor is applied would have the same level of damping.

In other embodiments the pre damping factor γ as determined by processing steps 709 or 711 can be weighted individually for a particular sub band. In such embodiments the sub-band gain determiner 308 can comprise a pre damping factor associator configured to, or means for associating the pre damping factor with a sub set of sub bands of the second part of the audio signal. In such embodiments the damping factor determiner configured to determine, or means for determining, the damping factor corresponding to each sub band gain of the sub set of sub bands can determine the damping factor by applying the sub band weighting factor associated with each sub band of the sub set of sub bands to the pre damping factor.

For instance in a first group of embodiments the pre damping factor γ for the audio frame may be tailored individually to provide a damping factor for a specific sub band gain. In other words the pre damping factor γ may be uniquely weighted for a specific sub band to provide a damping factor for that specific sub band gain.

In the first group of embodiments the pattern of weighting can be configured such that a greater damping factor is applied to sub band gains of the higher sub bands. Therefore in some embodiments the sub set of sub bands of the second part of the audio signal comprises a number of the highest frequency sub bands of the second part of the audio signal.

For example in the first group of embodiments the three highest sub bands can be individually damped by generating sub band dependent weights which can then be applied to the pre damping factor γ. The sub band dependent weights can be determined such that the pattern of damping amongst the highest sub bands is weighted to such that a progressively increasing level of damping is applied towards the higher sub bands. In other words the pattern of weighting is structured such that the highest level of damping is applied to the highest frequency sub band, and the next highest level of damping is applied to the penultimate highest frequency sub band and so on and so forth. In some of such embodiments the value of each sub band weighting factor can therefore increase monotonically with each sub band of the sub set of sub bands of the second part of the audio signal.

In this particular group of embodiments the above sub band dependent damping of sub band gains for the high frequency audio signal may be derived as

δⱼ=1ηⱼγ,

where δⱼ and ηⱼ represent the damping factor and weight for the sub band j respectively.

In the first group of embodiments the following sub band weights ηⱼ may be used in order to achieve the appropriate level of damping for the three highest sub bands

η_{J}=1

η_{J-1}=0.67

η_{J-2}=0.34

where J denotes the highest frequency sub band in the high frequency audio signal.

It is to be appreciated that the above values may be subjectively chosen using listening tests in order to produce an advantageous result.

In this particular example of a first group of embodiments all other sub bands bar the highest three of the high frequency audio signal may have no damping applied to them. In other words the damping factor applied to these other sub bands (sub bands 1 to J−3) will be 1.

It is to be understood that other groups of embodiments may apply damping over a larger range of sub bands. This may be implemented by simply deploying a larger set of sub band weights ηⱼ over which sub band specific damping factors are applied.

The step of determining the damping factor δⱼ for a sub set of the sub band gain by applying a sub band specific weight ηⱼ is shown as processing step 713 in FIG. 6.

In the first group of embodiments the damping factors δⱼ can be applied to the corresponding sub band linear domain scaling gains α₁(j). This can be applied by simply multiplying the linear domain scaling gain α₁(j) for a particular high frequency sub band j with the corresponding damping factor δⱼ.

It is to be understood that only those sub band gains for which the damping factors δⱼ have been determined are damped in this manner. The other sub band gains of the high frequency signal are each damped with the same minimum level of damping.

For example in the first group of embodiments only the sub band linear domain scaling gains (α₁(J−2), α₁(J−1), α₁(J)) relating to the three highest frequency sub bands are correspondingly weighted with the above determined damping factors (δ_{J-2}, δ_{J-1}, δ_{J}). The other sub band linear domain scaling gains (α₁(1) . . . α₁(J−3)) have a minimum level of damping of 1, in other words each effectively has no damping applied.

Other groups of embodiments may apply damping factors to other sub band gains. For example, in some embodiments damping factors may be applied to energy and logarithmic scaling gains.

The step of applying the damping factors δⱼ to the selected higher sub band gains is shown as processing step 715 in FIG. 6.

The step of applying a minimum level of damping or no damping to the sub band gains which do not constitute the set of selected higher sub bands is shown as processing step 717 in FIG. 6.

In other embodiments the sub band gain damper 308 may not deploy the decision step of 703. In these embodiments a minimum level of damping may be applied to the sub band gains of all the sub bands of the high frequency audio signal. Effectively these embodiments may derive the damping for each sub band by deploying the processing step 705.

In further other embodiments the sub band gain damper 308 may also not deploy the decision step of 703. However in these embodiments damping factors may be derived for each sub band gain by using the approach as outlined in processing steps 707 to 717. In such a group of embodiments the sub band gains associated with the higher sub bands may be damped with a damping factor derived from a pre damping factor, and the other sub bands may be damped with a damping factor delivering a minimum level of damping.

Therefore in some embodiments the sub-band gain damper 308 damping factor determiner is configured to, or the means for determining the damping factor can be configured to apply the minimum level of damping where the result of the comparison of the noise estimate to the energy threshold parameter indicates that the noise estimate is at least less than the energy threshold parameter.

With reference to the flow diagram of FIG. 5, the above processing steps for deriving and applying damping factors for the higher region sub band gains is shown as processing step 612.

In some embodiments the HFR coder may comprise a higher frequency region low bitrate extension coder 307 configured to receive the sub band matched index and other scaling parameters (which can also be known as match parameters) representing the higher frequency region sub-bands from the searcher 305. Additionally the higher frequency region low bitrate extension coder 307 may be further configured to receive an input from the sub band gain damper 308 comprising the sub band gains and damped sub band gains for the sub bands of the high frequency audio signal.

The HFR coder then generates a low bit rate extension by encoding means within the higher frequency region low bitrate extension coder 307.

The higher frequency region low bitrate extension coder 307 in some embodiments comprises an index divider 309. The index divider 309 is configured to divide the searched match parameters into two groups, a first group which is configured to be index encoded and a second group which is non-index encoded.

In some embodiments the index divider 309 is configured to perform the division using a fixed or determined process. For example where there are L higher frequency sub-bands the first A higher frequency sub-bands are determined to be index coded and the remaining L-A sub-bands are determined to be non-index encoded, where A is a fixed value. In some other embodiments the index divider is adaptive and dependent on the bitrate used or bit-rate capacity the value of A can change from frame to frame. In some embodiments the index divider can receive network or control information to adjust the value of A dependent on the network capacity or bit-rate generated from other parts of the encoder. In some embodiments the index divider 309 is configured to determine the lower frequency higher frequency sub-bands as being index encoded and the higher frequency sub-bands as being non-index encoded. In some further embodiments the index divider 309 can be configured to receive from the searcher the output of the search for a representative higher frequency sub-band and determine the most representative higher frequency sub-bands as being suitable for index encoding and the less representative higher frequency sub-bands as suitable for non-index encoding.

The index divider 309 is in such embodiments configured to pass the match parameters for index encoding to the quantizer 311 and the match parameters for non-index encoding to the initial position/point selector 315. In other words in some embodiments there are processing means for determining the first section of the second part of the audio signal such that the first encoded audio signal and second encoded audio signal is within a defined encoding efficiency parameter.

The operation of dividing the HFR sub-bands into index and non-index encoded forms is shown in FIG. 5 by step 613.

The higher frequency region low bit rate extension coder 307 in some embodiments comprises a quantizer 311. The quantizer 311 is configured to receive the match parameters for index encoding and generate suitable quantised outputs to be passed to the multiplexer 317 and represent the match parameters for the higher frequency region sub-bands.

The operation of quantizing the index form and outputting the quantized values is shown in FIG. 5 by step 615.

In some embodiments the code generator passes the gain values associated with the non-index coded sub-bands which are furthermore multiplexed by the multiplexer 317.

The quantized index and other gain or scaling parameters can then be multiplexed by the multiplexer 317 before being output as a higher frequency coder 232 output to a bitstream formatter 234.

The bitstream formatter 234 receives the lower frequency coder 231 output, the higher frequency region coder 232 output and formats the bitstream to produce the bitstream output. The bitstream formatter 234 in some embodiments of the invention may interleave the received inputs and may generate error detecting and error correcting codes to be inserted into the bitstream output 112.

The step of multiplexing the HFR coder 232 and LFR coder 231 information into the output bitstream is shown in FIG. 5 by step 617.

The apparatus therefore in some embodiments may further comprise combining means for combining the first encoded audio signal and the second encoded audio signal.

The apparatus in some embodiments further comprises data storage means for storing a combined first encoded audio signal and second encoded audio signal.

The apparatus in some embodiments further comprises transmitting means for transmitting a combined first encoded audio signal and second encoded audio signal.

Although the above examples describe embodiments of the invention operating within a codec within an apparatus 10, it would be appreciated that the invention as described below may be implemented as part of any audio (or speech) codec, including any variable rate/adaptive rate audio (or speech) codec. Thus, for example, embodiments of the invention may be implemented in an audio codec which may implement audio coding over fixed or wired communication paths.

Thus user equipment may comprise an audio codec such as those described in embodiments of the invention above.

It shall be appreciated that the term user equipment is intended to cover any suitable type of wireless user equipment, such as mobile telephones, portable data processing devices or portable web browsers.

Furthermore elements of a public land mobile network (PLMN) may also comprise audio codecs as described above.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Thus at least some embodiments of the encoder may be an apparatus comprising at least one processor and at least one memory including computer program code the at least one memory and the computer program code configured to, with the at least one processor, cause the apparatus at least to perform: determining at least one event from at least one audio signal, wherein the event comprises a region of frequency components of the at least one audio signal; generating a suppressed at least one audio signal by suppressing the at least one event from the at least one audio signal; and encoding at least one event from the at least one event.

In some embodiments of the decoder there may be an apparatus comprising at least one processor and at least one memory including computer program code the at least one memory and the computer program code configured to, with the at least one processor, cause the apparatus at least to perform: receiving at least one indicator representing at least one frequency component event from a region of frequency components; and modifying at least one frequency component within the at least one event dependent on the indicator.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions.

Thus at least some embodiments of the encoder may be a computer-readable medium encoded with instructions that, when executed by a computer perform: determining at least one event from at least one audio signal, wherein the event comprises a region of frequency components of the at least one audio signal; generating a suppressed at least one audio signal by suppressing the at least one event from the at least one audio signal; and encoding at least one event from the at least one event.

Furthermore at least some of the embodiments of the decoder may be provided a computer-readable medium encoded with instructions that, when executed by a computer perform: receiving at least one indicator representing at least one frequency component event from a region of frequency components; and modifying at least one frequency component within the at least one event dependent on the indicator.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

As used in this application, the term ‘circuitry’ refers to all of the following:
(a) hardware-only circuit implementations (such as implementations in only analog and/or digital circuitry) and
(b) to combinations of circuits and software (and/or firmware), such as: (i) to a combination of processor(s) or (ii) to portions of processor(s)/software (including digital signal processor(s)), software, and memory(ies) that work together to cause an apparatus, such as a mobile phone or server, to perform various functions and
(c) to circuits, such as a microprocessor(s) or a portion of a microprocessor(s), that require software or firmware for operation, even if the software or firmware is not physically present.

This definition of ‘circuitry’ applies to all uses of this term in this application, including any claims. As a further example, as used in this application, the term ‘circuitry’ would also cover an implementation of merely a processor (or multiple processors) or portion of a processor and its (or their) accompanying software and/or firmware. The term ‘circuitry’ would also cover, for example and if applicable to the particular claim element, a baseband integrated circuit or applications processor integrated circuit for a mobile phone or similar integrated circuit in server, a cellular network device, or other network device.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1-46. (canceled)

47. A method comprising:
determining a noise estimate for a first part of an audio signal;
comparing the noise estimate to an energy threshold parameter;
determining a damping factor for at least one sub band gain value of a second part of an audio signal, wherein the damping factor is dependent on a result of the comparison; and
applying the damping factor to the sub band gain value.

48. The method as claimed in claim 47, further comprising:
determining a pre damping factor for at least one sub band gain value of a second part of an audio signal, wherein the pre damping factor is dependent on a result of the comparison of the noise estimate to a further threshold parameter; and
determining a damping factor for the sub band gain value by applying a sub band related weighting factor to the pre damping factor for the at least one sub band gain value, wherein the sub band weighting factor is dependent on the sub band associated with the sub band gain value.

49. The method as claimed in claim 48, wherein when the result of the comparison indicates a first outcome the determining of the pre damping factor for the at least one sub band gain value of the second part of the audio signal comprises interpolating between a damping value and a further damping value.

50. The method as claimed in claim 49, wherein the damping value is associated with a minimum level of damping, wherein the further damping value is associated with a maximum level of damping, and wherein the interpolation is linear and is in proportion to the ratio of the value of the noise estimate relative to the energy range between the energy threshold parameter and the further energy threshold parameter.

51. The method as claimed in claim 48, wherein when the result of the comparison indicates a second outcome, the determining of the pre damping factor for the at least one sub band gain value of the second part of the audio signal comprises setting the pre damping factor to be a maximum level of damping

52. The method as claimed in claim 48, wherein the pre damping factor is associated with a sub set of sub bands of the second part of the audio signal, and wherein the damping factor corresponding to each sub band gain of the sub set of sub bands is determined by applying the sub band weighting factor associated with each sub band of the sub set of sub bands to the pre damping factor.

53. The method as claimed in claim 52, wherein the sub set of sub bands of the second part of the audio signal comprises a number of the highest frequency sub bands of the second part of the audio signal, and wherein the value of each sub band weighting factor increases monotonically with each sub band of the sub set of sub bands of the second part of the audio signal.

54. The method as claimed in claim 53, wherein the sub set of sub bands of the second part of the audio signal comprises the three highest frequency sub bands, wherein the sub band weighting factor corresponding to third highest frequency sub band is 0.34, wherein the sub band weighting factor corresponding to the second highest frequency sub band is 0.67, and wherein the sub band weighting factor corresponding to the highest frequency sub band is 1.0.

55. The method as claimed in claim 47, wherein when the result of the comparison of the noise estimate to the energy threshold parameter indicates that the noise estimate is at least less than the energy threshold parameter the damping factor is determined to be the minimum level of damping.

56. The method as claimed in claim 47, wherein the first part of the audio signal is a lower frequency region of the audio signal, and wherein the second part of the audio signal is a higher frequency region of the audio signal.

57. Apparatus comprising at least one processor and at least one memory including computer code, the at least one memory and the computer code configured to with the at least one processor cause the apparatus to at least:
determine a noise estimate for a first part of an audio signal;
compare the noise estimate to an energy threshold parameter;
determine a damping factor for at least one sub band gain value of a second part of an audio signal, wherein the damping factor is dependent on a result of the comparison; and
apply the damping factor to the sub band gain value.

58. The apparatus as claimed in claim 57, further caused to:
determine a pre damping factor for at least one sub band gain value of a second part of an audio signal, wherein the pre damping factor is dependent on a result of the comparison of the noise estimate to a further threshold parameter; and
determine a damping factor for the sub band gain value by causing the apparatus to apply a sub band related weighting factor to the pre damping factor for the at least one sub band gain value, wherein the sub band weighting factor is dependent on the sub band associated with the sub band gain value.

59. The apparatus as claimed in claim 58, wherein determine of the pre damping factor for the at least one sub band gain value of the second part of the audio signal causes the apparatus to interpolate between a damping value and a further damping value when the result of the comparison indicates a first outcome.

60. The apparatus as claimed in claim 59, wherein the damping value is associated with a minimum level of damping and the further damping value is associated with a maximum level of damping, wherein interpolate between a damping value and a further damping value causes the apparatus tolinear interpolate in proportion to the ratio of the value of the noise estimate relative to the energy range between the energy threshold parameter and the further energy threshold parameter.

61. The apparatus as claimed in claim 58, wherein determine of the pre damping factor for the at least one sub band gain value of the second part of the audio signal causes the apparatus to set the pre damping factor to be a maximum level of damping when the result of the comparison indicates a second outcome.

62. The apparatus as claimed in claim 58, further caused to associate the pre damping factor with a sub set of sub bands of the second part of the audio signal, and determine the damping factor corresponding to each sub band gain of the sub set of sub bands by applying the sub band weighting factor associated with each sub band of the sub set of sub bands to the pre damping factor.

63. The apparatus as claimed in claim 62, wherein the sub set of sub bands of the second part of the audio signal comprises a number of the highest frequency sub bands of the second part of the audio signal, and wherein the value of each sub band weighting factor increases monotonically with each sub band of the sub set of sub bands of the second part of the audio signal.

64. The apparatus as claimed in claim 63, wherein the sub set of sub bands of the second part of the audio signal comprises the three highest frequency sub bands, wherein the sub band weighting factor corresponding to third highest frequency sub band is 0.34, wherein the sub band weighting factor corresponding to the second highest frequency sub band is 0.67, and wherein the sub band weighting factor corresponding to the highest frequency sub band is 1.0.

65. The apparatus as claimed in claim 57, wherein determine a damping factor for at least one sub band gain value of a second part of an audio signal causes the apparatus to determine the damping factor to be the minimum level of damping where the result of the comparison of the noise estimate to the energy threshold parameter indicates that the noise estimate is at least less than the energy threshold parameter.

66. The apparatus as claimed in claim 57, wherein the first part of the audio signal is a lower frequency region of the audio signal, and wherein the second part of the audio signal is a higher frequency region of the audio signal.
